(19) United States
(12) Patent Application Publication
(10) Pub. No.: US 2005/0091887 A1
(43) Pub. Date: May 5, 2005

(54) Folding annotation device

(75) Inventors: R. Steven Jones, Evergreen, CO (US); Gary J. Klembara, Richardson, TX (US)

Correspondence Address: Bryan F. Erickson;Westman, Champlin & Kelly, Suite 1600, 900 Second Avenue South, Minneapolis, MN, 55402-3319, US

(73) Assignee: Dealworks Group, LLC, Richardson, TX (US)

(21) Appl. No.: 10/977,097

(22) Filed: Oct. 29, 2004

Related U.S. Application Data
(60) Provisional application No. 60/517,328, filed on Nov. 4, 2003.

(51) Int. Cl. G09F 1/00

(52) U.S. Cl. 40/124.09

(57) ABSTRACT

A folding device is composed of a disposable paper product, and includes a number of panels connected to each other via shared folding junctions. At least some of these panels include preprinted content, some of which includes indications for new content to be written responsively to the preprinted content in corresponding blank spaces. A wide variety of business, informative, and advertising/promotional interactive content is thereby provided in a surprisingly novel format, which doubles as a mundane functional object such as a napkin. This double function allows the folding annotation device to be disbursed widely in social settings where it can be readily and conveniently available to perform more sophisticated functions including conveying informative, advertising/promotional and other content along with indications for the users to record their own written content responsively to the preprinted content. For example, this may provide the synergy of allowing deal-makers to be reminded of and to record specific terms of an agreement on the spot, with a tool that remains surprisingly conducive to an easygoing, social atmosphere conducive to completing such an agreement.

### CROSS-REFERENCE TO RELATED APPLICATION

This application claims the benefit of U.S. provisional patent application Ser. No. 60/517,328, filed on Nov. 4, 2003, which is incorporated by reference herein.

### FIELD OF THE INVENTION

The present invention relates to the field of folding devices for information, education, entertainment, advertising, promotion, and other purposes.

### BACKGROUND OF THE INVENTION

There has been a great need, and corresponding market, for various formats of information devices having information printed on several surfaces associated with each other but not joined together as part of the same surface. A useful subset of these devices also includes spaces, regions or entries for a user to write notations of her own, with these spaces organized relative to the preprinted information in such a way as to optimize any of several useful functions for the user. A representative sampling of these devices includes pocket calendars, executive planners, workbooks, scheduling folders, binders, multiple-part contract forms, promotional booklets, and further examples.

There is also a persistent need for cost-effective and innovative methods of advertising and promoting awareness of a message or a source of products or services. There is a tremendous and apparently ever-growing rise in nontraditional formats for advertisement and promotion that adapt new ideas and new technologies, both advanced and relatively simple, to these purposes. Rather than showing signs of slowing, this trend signals that the need for novel advertising and promotion formats persists.

### SUMMARY OF THE INVENTION

One goal of the present invention, according to one embodiment, includes providing a new level of ease and convenience in deal-making. There is a persistent and largely unaddressed paradox in business and other deal-making settings, wherein deals or agreements should or must be recorded in specific terms of a clearly defined contract to protect the interests of the individuals forming the agreement; yet the deals arise in an informal or ad hoc environment, or the deal-makers may prefer to make deals with each other in a casual manner that displays camaraderie and trust, and to which, for example, the immediate involvement of lawyers insisting on rigorous contract terms is not perceived to be conducive or practical.

According to the goals of the present invention, a pragmatic and unique compromise is provided, whereby an object that may take as harmless a form as an apparent napkin may fill in for the parties, guiding the deal-makers through the important and necessary steps of setting clear and clearly recorded terms to an agreement, even while preserving a casual and enjoyable manner, even perhaps enhancing that manner by the surprise and amusing novelty of the napkin's unusual nature. The device may also be optimized for being conveniently available in a typical, casual setting in which an agreement might be formed, even between parties who first meet in that setting. For example, in a napkin format, the device may be placed in the open and available to the public in a variety of social settings, such as restaurants, clubs, cafés, hotel lobbies, company break-rooms, airport lounges and airliners, golf course clubhouses, and drinking establishments.

Each panel of the napkin, in an illustrative embodiment, may include important information and/or related spaces for the deal-makers to annotate by filling in responses to specified inquiries. In this way, specific terms of an agreement may be recorded as the agreement is formed, using a simple, on site, found object that does not require advance planning or overly formal or intrusive elements that might impede the deal-making scenario.

Another goal of embodiments of the present invention is to provide a novel, innovative format for advertising and promotion. An embodiment of the invention may be well-suited for having a logo, trademark, message, or other advertising or promotional material placed thereon. Providing this new format may assist in the device fulfilling a need for a novel, innovative advertising or promotional format to parties who provide and disseminate devices of the present invention. There is also the opportunity for synergistic combination of the advertising or promotional purpose with the purposes of facilitating deal-making or otherwise providing information and indicating additional content to be added responsively thereto. For example, the information and/or indicated new content for a user to add may tie in to the business of the sponsor or owner of the logo, trademark, or message provided on the devices. As another example, the devices may be aimed at use by a target audience of the sponsor or owner of such a logo, trademark, or message.

Additional objects, features, and advantages of the present invention may be discerned through the corresponding description and figures, and inferred by those in the art from the general teaching of the present disclosure and in the course of practicing, manufacturing, using, and otherwise experiencing different embodiments, as defined by the appended claims.

### BRIEF DESCRIPTION OF THE DRAWINGS

FIG. 1 shows a plan view of a folding annotation device in a folded state, according to one embodiment.

FIG. 2 shows a plan view of a folding annotation device in an unfolded state, according to one embodiment.

FIG. 3 shows a perspective view of a folding annotation device in a slightly unfolded state, according to one embodiment.

FIG. 4 shows a plan view of a folding annotation device in an unfolded state, according to one embodiment.

FIG. 5 shows a perspective view of a folding annotation device in a folded state, in a typical context for convenient placement awaiting usage, according to one embodiment.

### DETAILED DESCRIPTION OF ILLUSTRATIVE EMBODIMENTS

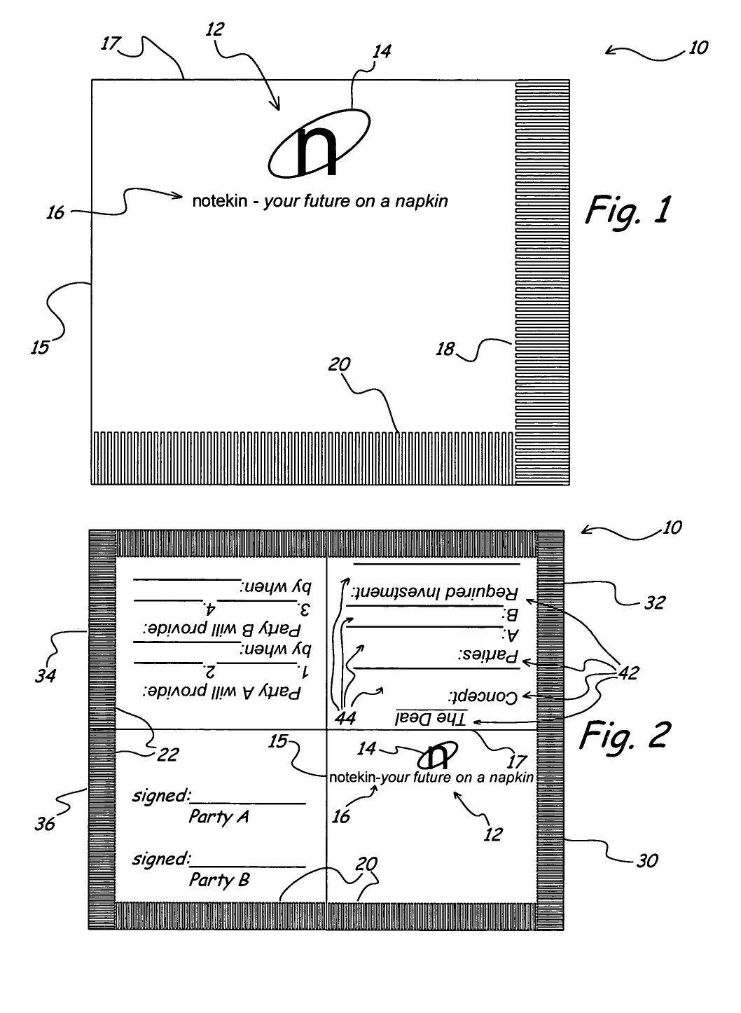

FIG. 1 shows a plan view of a folding annotation device in a folded state, according to one embodiment. The folding annotation device 10 is an annotation napkin with a number of folds therein defining a number of panels having information printed thereon, in this embodiment. Only one of these panels is visible in the folded state depicted in FIG. 1.

The visible panel in FIG. 1 includes a preprinted set of content 12, which includes symbol 14 and slogan 16, both of which could hypothetically function as trademarks, and particularly as commercial source identifiers. In this particular case, the content happens to provide information about a commercial source of the annotation napkins themselves. In other embodiments, the preprinted content could include any trademark, or other advertising/promotional content. The variety of content that might be used for the important function of advertising and/or promotional purposes is broad, and there is no absolute distinction between advertising and promoting per se, so it is easier to refer to the combination as advertising/promotional content. Annotation napkin 10 thereby provides a novel and non-traditional format for advertisement and promotion.

In still other embodiments, the preprinted content could include baseball statistics, or nutrition information, or physics equations, or bullet points for a political platform, or any other type of information. It may be advantageous in many of these embodiments for the front panel also to include an indication for the user to unfold the annotation napkin to discover further information and to use the indicated annotation spaces, which are illustrated in FIG. 2.

Annotated napkin 10 is composed of a substantially absorbent, disposable paper product. That is, annotated napkin 10 has an absorbency that a typical user might find well suited to absorbing at least a small spill of a liquid such as a drink. This substantial absorbency is therefore considerably greater than any negligible absorbency that might be exhibited by regular paper of the sort commonly used for providing printed information on or writing on.

Annotation napkin 10 may be unfolded first about folding junction 15, then about folding junction 17, which the front panel, visible in FIG. 1, shares with additional panels, and by which the corresponding panels are connected to each other. The front panel also includes vertical embossed periphery 18 and horizontal embossed periphery 20, which increase the local surface area density of the annotation napkin 10 and thereby help make the annotation napkin 10 more absorbent. The absorbency of annotation napkin 10 contributes to its double role as a functioning napkin, and thereby contributing to its greater function of being far more likely to be widely dispersed and available in casual social settings despite its useful function as an annotation device.

FIG. 2 shows a plan view of annotation napkin 10 as an embodiment of a folding annotation device in an unfolded state, consistent with the embodiment of FIG. 1. Preprinted trademark content 12 including symbol 14 and word mark 16 are visible once again. Shared folding junctions 15 and 17 are also again visible, now in better context with respect to front panel 30 that was seen in FIG. 1, as well as additional panels 32, 34 and 36. Specifically, front panel 30 and panel 32 are joined to panels 34 and 36 via shared fold 15; while front panel 30 and panel 36 are joined to panels 32 and 34 via shared fold 17. Shared folds 15 and 17 are a simple example of a variety of shared folding junctions that may be used in different embodiments.

Annotation napkin 10 is printed in such a way in the embodiment of FIG. 2 that it may be opened like a booklet along shared fold 15 and shared fold 17 left folded, such that panels 32 and 34 function as the inner pages of the booklet, panel 36 functions as the back cover, and all four panels will be right side up in the same orientation. As is demonstrated in FIG. 2, when annotated napkin 10 is completely unfolded, the orientation of the text from one panel to another may be substantially different. For example, the text comprised in the preprinted content on panels 32 and 34 is oriented at a 180 degree angle to the text comprised in the preprinted content on panels 30 and 36, in this example. This difference in orientation of the text when annotated napkin 10 is completely unfolded allows the text to have the same orientation during some actions of folding and unfolding when the annotation napkin 10 is in at least a partly folded state. Additional differences in orientation may allow two different users seated opposite each other to view a respective set of content in respectively upright orientations relative to their different positions, for example, or even include three or more substantially different orientations to allow three or more different users each to view a respective set of content upright relative to their own positions, for example.

Each of the panels also includes a section of embossed periphery such as at horizontal embossed periphery 20 and vertical embossed periphery 22, for example, further contributing to the absorbent function of annotation napkin 10. Each of the additional panels 32, 34, 36 of annotation napkin 10 includes both a set of preprinted content, and a number of defined blank spaces with indications of new content to be annotated in the blank spaces. Lines contribute to defining the blank spaces as corresponding with certain preprinted content including indications of what new content to add thereon responsively to the preprinted content. Included in the preprinted content of each of panels 32, 34 and 36 is a title at the top of the respective panel, descriptive of the preprinted content on that respective panel. The font size of the preprinted content relative to the size of annotation napkin 10 is exaggerated in the depiction of FIG. 2 in the interests of legibility.

Panel 32 for example includes preprinted content 42 and blank spaces 44 with indications of new, additional content to be written or annotated therein by a user. Panel 34 includes further preprinted content and blank spaces with indications of new content to be annotated therein, wherein the indications of new content to be annotated in the blank spaces comprises indications to record what users will each do or provide as their part of an agreement, along with a deadline by which their performance of their part of the agreement shall be fulfilled. Panel 36 includes preprinted content comprising indications for at least two parties to an agreement to sign their signatures in corresponding blank spaces. Indications of what new content to write or annotate in a blank space may be one form of the preprinted content of any of the panels, in additional embodiments.

One useful, novel and unexpected advantage of embodiments of the present invention, illustrated by annotation napkin 10, is that each unfolding of the folding annotation device progressively reveals a little more detail in terms of preprinted content and indications for additional content to be added by a user, while not presenting any more detail than is necessary for a given stage of use. This prevents the folding annotation device from making an overwhelming or intimidating impression by exposing a user to an appearance of more detail than is necessary or perhaps wanted at a given stage of use. This sets folding annotation device 10 apart from certain alternatives such as a traditional file, binder, ledger, or multi-part contract form, which from their very appearance may intimidate or cast a shadow over a convivial social setting. This is contrasted with the initial appearance of annotation napkin 10, which appears merely as a napkin, perhaps with an amusing or eye-catching set of preprinted content on its front panel, and which still only shows a discrete and progressively rising level of detail at each unfolding, accompanied by the novelty and amusement at the unusual nature and usefulness of such a sophisticated napkin. Various embodiments of a folding annotation device 10 thereby preserve a convivial mood conducive to forming agreements, even while indicating to users who choose to unfold it and use its annotation function, of rigorous terms that should be applied to such agreements, and providing a tool for such terms to be permanently recorded.

FIG. 3 shows a perspective view of a folding annotation device 110 in a slightly unfolded state, according to an embodiment somewhat different from FIGS. 1 and 2. Much of the content on the various panels depicted in FIG. 2 is omitted in FIG. 3; any of a wide variety of content may be preprinted on annotation napkin 110. While folding annotation device 110 takes the form of an annotation napkin sharing in common the front trademark and folds of FIGS. 1 and 2, the embodiment of FIG. 3 further includes another shared fold 122 by which annotation napkin 122 may further unfold. This doubles the area available for content, including on inner page 130. Annotation napkin 110 also has embossed peripheries 118, 120 on three sides of each of its two larger pages, but not along shared folding junction 122, in this embodiment.

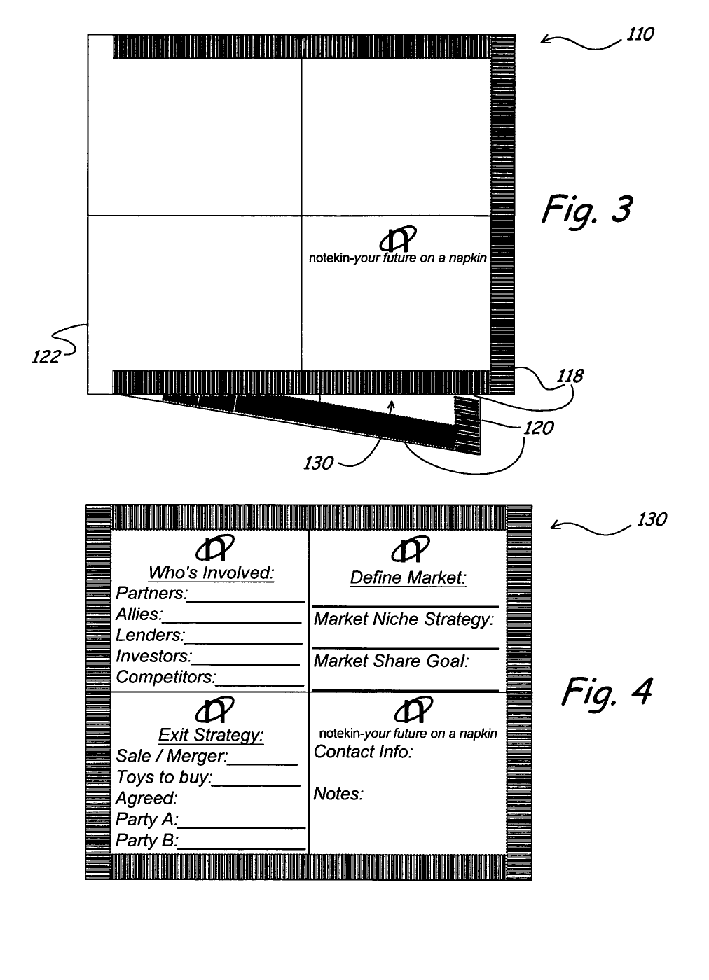

FIG. 4 shows a plan view of a folding annotation device in an unfolded state, according to one embodiment. In particular, FIG. 4 depicts inner page 130 of annotation napkin 110, corresponding to the embodiment of FIG. 3. FIG. 4 includes several additional panels, providing a wealth of additional preprinted content, along with blank spaces and indications comprised in the preprinted content for what additional, user-generated content should be annotated into the blank spaces. Additional preprinted content may include flow charts, options for terms of a contract, additional advertising/promotional content, etc.

The various panels of inner page 130 may also include further indications for additional content to be written in by a user responsively to the preprinted content. That is, the user may write the new content in response to questions, promptings, or suggestions provided in the preprinted content; or by selecting from among options provided in the preprinted content; or by signing one's signature in a corresponding blank space above a corresponding line; or merely by taking notes or brainstorming responsively to the general or overall suggestions of the preprinted content, for example. The user might also write new content in the corresponding blank spaces responsively to the printed content by, for example, recording elements to be fulfilled for an agreement, and recording a deadline by which the elements should be fulfilled, for example. Additional modes of writing responsively to the preprinted content may also occur in various embodiments. Illustrative examples of additional indications for further content to be added responsively to the preprinted content include indications of elements of a business strategy, indication of elements of performance for a contract, or indications to provide feedback on survey questions, for example.

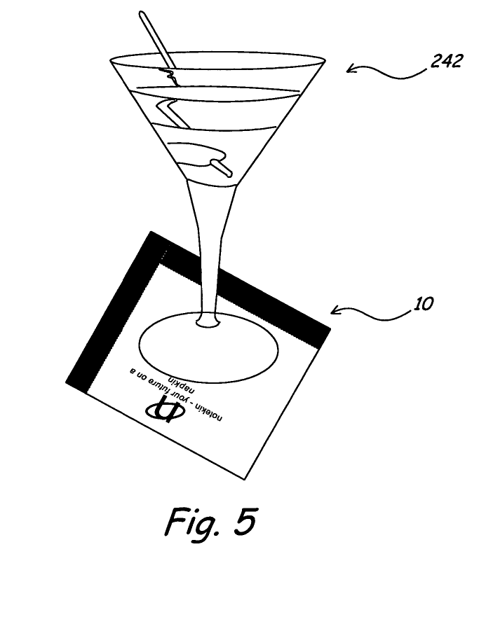

FIG. 5 shows a perspective view of a annotation napkin 10 in a folded state, according to one embodiment of a folding annotation device, in a typical context for convenient placement awaiting usage. In particular, annotation napkin 10 has been deployed with martini 242 set on top of it. In this context, annotated napkin 10 serves both the function of a conventional napkin, and of an almost surreptitiously convenient annotation device and business aid. If the jovial mood enjoyed by the consumer of the martini 242 and a companion in this social setting leads to a mutual desire to form an agreement to cooperate together in the future, they may simply unfold annotation napkin 10 to assist them in having relevant information important for their deal-making at their fingertips, and in being guided and reminded as to important indications for new content to be added responsively to the preprinted content, that may be recorded on the spot. This function is thereby performed with a convenience and conduciveness to deal-making that simply would not be available with more traditional, more intrusive or intimidating annotation devices or business aids. Additional purposes may be served, such as the exposure of the users to advertising or promotional material, such as a trademark or other source identifier, on the annotation napkins.

Although the present invention has been described with reference to illustrative embodiments, workers skilled in the art will recognize that changes may be made in form and detail without departing from the spirit and scope of the invention. For example, while examples of annotation napkins have been described and depicted, other embodiments of folding annotation devices may come in other forms and dimensions, such as a placemat or tablecloth, or roll of butcher paper, for example. A few other illustrative examples of folding annotation devices may include a study guide, a devotional or inspirational booklet, a political pamphlet, or an airdrop leaflet; or folding annotation devices that function as games or for amusement, as in a “mad lib”, a memory game, or a drinking game, for example. These examples are illustrative of a wide variety of additional functions and forms of content in which embodiments of the folding annotation device may be usefully adopted.

1. A folding device composed of a substantially absorbent, disposable paper product, the folding device comprising:
a first panel comprising a first preprinted set of content; and
a second panel, connected to the first panel via a shared folding junction of the disposable paper product, the second panel comprising a second set of preprinted content, and a blank space, and an indication of new content to be written in the blank space responsively to the preprinted content.

2. The folding device of claim 1, wherein the device is a napkin.

3. The folding device of claim 1, further comprising one or more additional content panels connected in the device via a shared folding junction, wherein each of the one or more additional content panels comprises a respective set of preprinted content.

4. The folding device of claim 3, wherein at least one of the one or more additional content panels further comprises a respective blank space, and a respective indication of content to be annotated in the respective blank space.

5. The folding device of claim 1, wherein the second set of preprinted content describes information relating to a preselected type of agreement, and the indication of new content to be written in the blank space comprises an indication inquiring on a preselected aspect of the preselected type of agreement.

6. The folding device of claim 1, wherein the second set of preprinted content describes a preselected subject, and the indication of new content to be written in the blank space comprises an indication inquiring for feedback relating to the subject.

7. The folding device of claim 1, wherein the indication of new content to be written in the blank space comprises an indication of elements of a business strategy.

8. The folding device of claim 1, wherein the indication of new content to be written in the blank space comprises an indication of elements of performance for a contract.

9. The folding device of claim 1, wherein the indications of new content to be written in the blank spaces comprise indications to record a deadline by which performance of an element of a contract shall be fulfilled.

10. The folding device of claim 1, wherein the indication of new content to be written in the blank space comprises an indication to sign a signature in a corresponding blank space above a corresponding line.

11. The device of claim 1, wherein the indication of new content to be written in the blank space comprises an indication to provide feedback on at least one survey question in a corresponding blank space.

12. The folding device of claim 1, wherein the first panel and the second panel each comprise a title in an upper region of the respective panel, each title descriptive of the respective content on the respective panel.

13. The folding device of claim 1, wherein the content of at least one of the panels comprises a flow chart.

14. The folding device of claim 1, wherein the content of at least one of the panels comprises options for terms of a contract.

15. The folding device of claim 1, wherein the content of at least one of the panels comprises advertising/promotional content.

16. The folding device of claim 15, wherein the advertising/promotional content comprises content from the group of source identifiers consisting of a trademark, a trade dress, a service mark, a regional identifier, a communal mark, and a certification mark.

17. The device of claim 1, wherein the first set of content comprises text oriented in a first orientation when the folding device is completely unfolded, and the second set of content comprises text oriented in a second orientation substantially different from the first direction when the folding device is completely unfolded.

18. The device of claim 17, further comprising at least one additional panel connected via a second shared folding junction, the additional panel comprising a third set of content comprising text oriented in a third orientation substantially different from both the first and second orientations when the folding device is completely unfolded.

19. An folding device composed of a substantially absorbent disposable paper product, the folding device comprising:
a first panel, and
a second panel connected to the first panel via a shared folding junction,
the first panel visible when the folding device is in a folded state, the first panel comprising a first preprinted set of content; and
a second panel that is obscured by the first panel when the folding device is in the folded state, the second panel being visible when the folding device is in an unfolded state, the second panel comprising a second set of preprinted content, and a blank space, and an indication of new content to be written in the blank space responsively to the preprinted content.

20. The folding device of claim 19, further comprising a first blank space comprised on the first panel, and a first indication of new content to be written in the initial blank space.

21. The folding device of claim 19, further comprising a third panel connected to at least one of the first panel and the second panel via a shared folding junction, the third panel comprising a third set of preprinted content, and a third panel blank space, and a third panel indication of content to be written in the third panel blank space.

22. The folding device of claim 19, further comprising at least one additional panel connected in the device via a shared folding junction, each of the at least one additional panel comprising a respective set of preprinted content.

23. The folding device of claim 22, wherein at least one of the at least one additional panel further comprises a respective blank space, and a respective indication of content to be written in the respective blank space.

24. A folding device composed of a substantially absorbent, disposable paper product, the folding device comprising:
a first panel comprising a first set of preprinted content, comprising text oriented in a first orientation when the folding device is completely unfolded;
a second panel, connected to the first panel via a first shared folding junction, the second panel comprising a second set of preprinted content comprising text oriented in a second orientation when the folding device is completely unfolded, wherein the second orientation is substantially different than the first orientation;
wherein the preprinted content on at least one of the panels comprises an indication of new content to be written in a blank space on at least one of the panels responsively to the preprinted content.

25. The folding device of claim 24, further comprising a third panel and a fourth panel, connected to the first panel and the second panel via a second shared folding junction, the third panel and the fourth panel comprising preprinted text oriented in a third orientation substantially different than the first orientation and the second orientation.
